(19) United States
(12) Patent Application Publication
(10) Pub. No.: US 2021/0045567 A1
(43) Pub. Date: Feb. 18, 2021

(54) Coring Knife Apparatus

(71) Applicant: Thomas Steigerwald, Wexford, PA (US)

(72) Inventor: Thomas Steigerwald, Wexford, PA (US)

(21) Appl. No.: 16/541,234

(22) Filed: Aug. 15, 2019

(51) Int. Cl. A47J 25/00

(52) U.S. Cl. CPC A47J 25/00

(57) ABSTRACT

A coring knife apparatus for easily coring fruits and vegetables includes a handle having a butt end, a front end, a top side, a bottom side, a left side, and a right side. The front end has a blade cavity extending towards the butt end. A shank is coupled to the handle within the blade cavity. A blade is coupled to the shank and comprises a main portion and a bent portion. The main portion is coupled to the shank and extends from adjacent the front end of the handle. The bent portion lies in a plane perpendicular to a plane of the main portion. The blade has a right edge and a left edge tapering along the main portion and the bent portion to a meet at a tip.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to knives and more particularly pertains to a new knife for easily coring fruits and vegetables.

### BRIEF SUMMARY OF THE INVENTION

An embodiment of the disclosure meets the needs presented above by generally comprising a handle having a butt end, a front end, a top side, a bottom side, a left side, and a right side. The front end has a blade cavity extending towards the butt end. A shank is coupled to the handle within the blade cavity. A blade is coupled to the shank and comprises a main portion and a bent portion. The main portion is coupled to the shank and extends from adjacent the front end of the handle. The bent portion lies in a plane perpendicular to a plane of the main portion. The blade has a right edge and a left edge tapering along the main portion and the bent portion to a meet at a tip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a coring knife apparatus according to an embodiment of the disclosure.

FIG. 2 is an isometric view of an embodiment of the disclosure.

FIG. 3 is a top plan view of an embodiment of the disclosure.

FIG. 4 is a front elevation view of an embodiment of the disclosure.

FIG. 5 is a side elevation view of an embodiment of the disclosure.

### DETAILED DESCRIPTION OF THE INVENTION

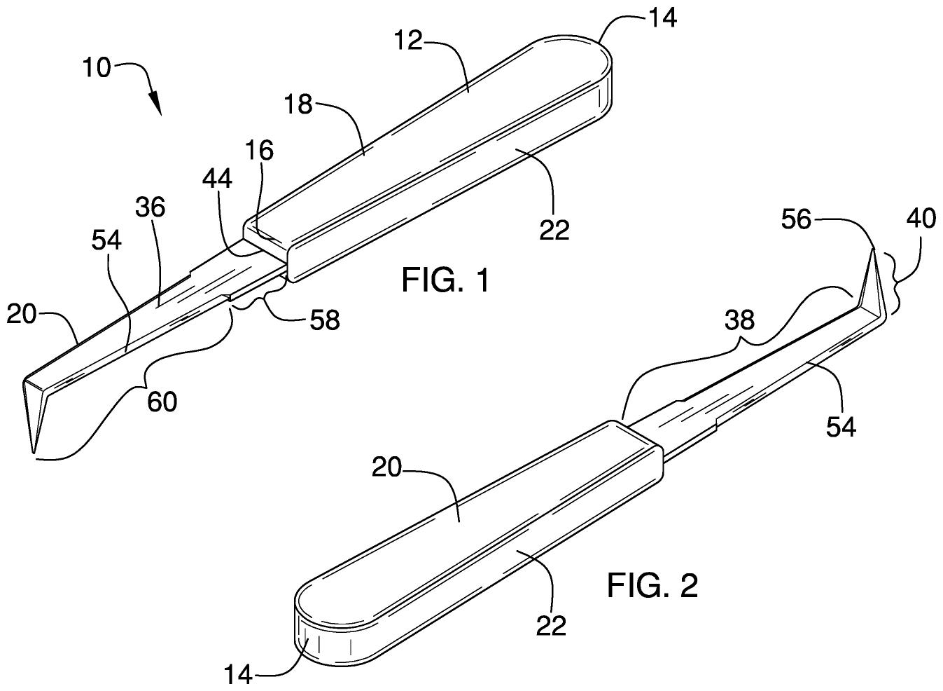

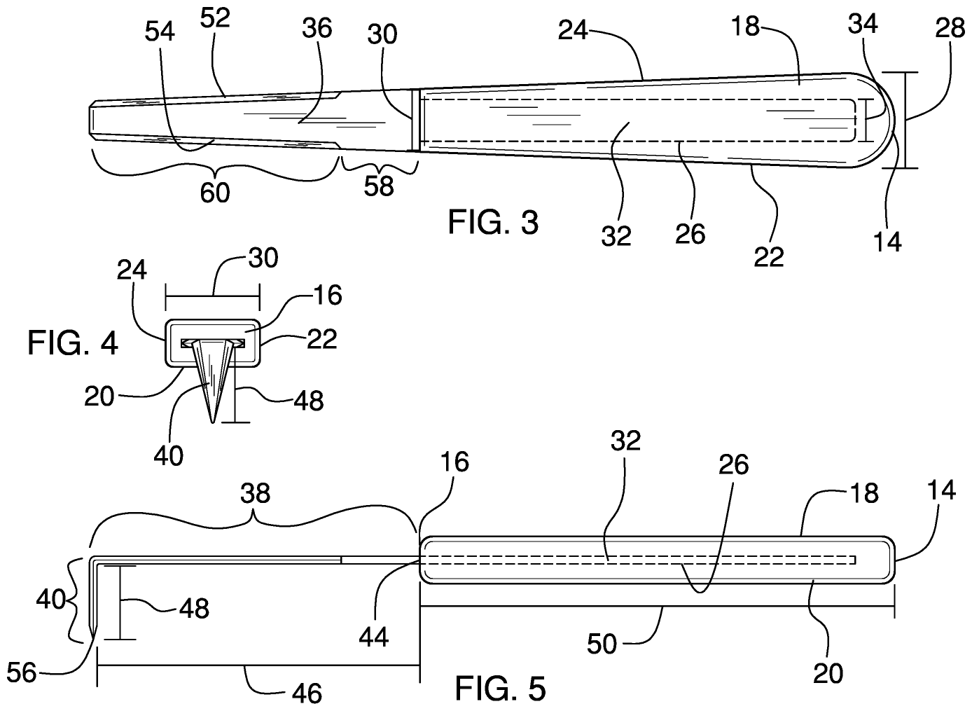

With reference now to the drawings, and in particular to FIGS. 1 through 5 thereof, a new knife embodying the principles and concepts of an embodiment of the disclosure and generally designated by the reference numeral 10 will be described.

As best illustrated in FIGS. 1 through 5, the coring knife apparatus 10 generally comprises a handle 12 having a butt end 14, a front end 16, a top side 18, a bottom side 20, a left side 22, and a right side 24. The front end 16 has a blade cavity 26 extending to proximal the butt end 14. The handle 12 tapers wider from the front end 16 to the butt end 14 and the butt end 14 is rounded to create a more ergonomic grip for a user's hand. The butt end 14 has a butt width 28 equal to 1.5 times a front width 30 of the front end 16.

A shank 32 is coupled to the handle 12 within the blade cavity 26 to proximal the butt end 14 for increased strength and to prevent separation from the handle 12. The shank 32 may be rectangular and has a shank width 34 less than the front width 30. A blade 36 is coupled to the shank 32 and comprises a main portion 38 and a bent portion 40. The main portion 38 is coupled to the shank 32 and extends from adjacent the front end 16 of the handle. A blade width 42 of a shank end 44 of the blade adjacent the front end 16 is equal to the front width 30 of the front end. The bent portion 40 lies in a plane perpendicular to a plane of the main portion 38. A main length 46 of the main portion 38 is equal to seven times a bent length 48 of the bent portion 40. The main length 46 ideally is 2.625″ and the bent length 48 is ideally 0.375″. A handle length 50 of the handle 12 is ten times the bent length 48. The handle length 50 is thus ideally 3.75″. The blade 36 has a right edge 52 and a left edge 54 each tapering along the main portion 38 and the bent portion 40 to a meet at a tip 56. Each of the right edge 52 and the left edge 54 has a dull portion 58 adjacent the front end 16 of the handle and a sharp portion 60 extending from the dull portion 58 to the tip 56. The dull portion 58 occupies less than 25% of the main portion 38.

In use, the handle 12 is secured and the blade 36 is inserted into a vegetable such as a bell pepper. The apparatus 10 is then manipulated in either direction, clockwise or counterclockwise, to create a circular cutting to extract the core of the vegetable. The blade 36 may then be used to scrape out seeds and the bent portion 40 may be used to extract said seeds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A coring knife apparatus comprising:
a handle, the handle having a butt end, a front end, a top side, a bottom side, a left side, and a right side, the front end having a blade cavity extending towards the butt end;
a shank coupled to the handle, the shank being coupled within the blade cavity; and
a blade coupled to the shank, the blade comprising a main portion and a bent portion, the main portion being coupled to the shank and extending from adjacent the front end, the bent portion lying in a plane perpendicular to a plane of the main portion, the blade having a right edge and a left edge tapering along the main portion and the bent portion to a meet at a tip.

2. The coring knife apparatus of claim 1 further comprising each of the right edge and the left edge being sharpened.

3. The coring knife apparatus of claim 1 further comprising each of the right edge and the left edge having a dull portion adjacent the front end of the handle and a sharp portion extending from the dull portion to the tip.

4. The coring knife apparatus of claim 3 further comprising the dull portion occupying less than 25% of the main portion.

5. The coring knife apparatus of claim 1 further comprising the handle tapering wider from the front end to the butt end, the butt end being rounded.

6. The coring knife apparatus of claim 5 further comprising the butt end having a butt width equal to 1.5 times a front width of the front end.

7. The coring knife apparatus of claim 1 further comprising a blade width of a shank end of the blade adjacent the front end being equal to a front width of the front end.

8. The coring knife apparatus of claim 1 further comprising the shank extending to proximal the butt end.

9. The coring knife apparatus of claim 1 further comprising a main length of the main portion being equal to seven times a bent length of the bent portion.

10. A coring knife apparatus comprising:
a handle, the handle having a butt end, a front end, a top side, a bottom side, a left side, and a right side, the front end having a blade cavity extending to proximal the butt end, the handle tapering wider from the front end to the butt end, the butt end being rounded, the butt end having a butt width equal to 1.5 times a front width of the front end;
a shank coupled to the handle, the shank being coupled within the blade cavity to proximal the butt end; and
a blade coupled to the shank, the blade comprising a main portion and a bent portion, the main portion being coupled to the shank and extending from adjacent the front end, a blade width of a shank end of the blade adjacent the front end being equal to the front width of the front end, the bent portion lying in a plane perpendicular to a plane of the main portion, a main length of the main portion being equal to seven times a bent length of the bent portion, the blade having a right edge and a left edge tapering along the main portion and the bent portion to a meet at a tip, each of the right edge and the left edge having a dull portion adjacent the front end of the handle and a sharp portion extending from the dull portion to the tip, the dull portion occupying less than 25% of the main portion.
